(19) United States
(12) Patent Application Publication
(10) Pub. No.: US 2023/0077840 A1
(43) Pub. Date: Mar. 16, 2023

(54) MACHINE LEARNING MODEL FOR SPECIALTY KNOWLEDGE BASE

(71) Applicant: Microsoft Technology Licensing, LLC, Redmond, WA (US)

(72) Inventors: Liwei WU, Davis, CA (US); Sebastian Alexander Csar, New York, NY (US); Lin ZHU, Santa Clara, CA (US); Yanen LI, Foster City, CA (US)

(21) Appl. No.: 17/477,302

(22) Filed: Sep. 16, 2021

(51) Int. Cl. G06N 5/02; G06F 16/901; G06Q 10/06

(52) U.S. Cl. CPC G06N 5/022; G06F 16/9024; G06Q 10/063112

(57) ABSTRACT

Techniques for predicting specialty data for a knowledge base using a machine learning model are disclosed herein. In some embodiments, a computer-implemented method comprises: for each skill in a plurality of skills, computing a skill-to-specialty distribution for specialties using a first machine learning model; for each skill in the plurality of skills, computing a user-to-skill distribution for the plurality of skills based on feature data of a first user of an online service using a second machine learning model; computing a user-to-specialty distribution for the plurality of specialties based on the skill-to-specialty distribution and the user-to-skill distribution, the user-to-specialty distribution comprising a corresponding user-to-specialty probability value for each specialty in the plurality of specialties given the first user; and using the user-to-specialty distribution in an application of the online service.

### TECHNICAL FIELD

The present application relates generally to predicting specialty data for a knowledge base using a machine learning model.

### BACKGROUND

Online service providers, such as social networking services, e-commerce and marketplace services, photo sharing services, job hosting services, educational and learning services, and many others, typically require that each end-user register with the individual service to establish a user account. In most instances, a user account will include or be associated with a user profile—a digital representation of a person's identity. As such, a user profile may include a wide variety of information about the user, which may vary significantly depending upon the particular type and nature of the online service. By way of example, in the context of a social networking service, a user's profile may include information such as: first and last name, e-mail address, age, location of residence, a summary of the user's educational background, job history, and/or experiences, as well as individual skills possessed by the user. A user profile may include a combination of structured and unstructured data. For example, whereas a user's age may be stored in a specific data field as structured data, other profile information may be inferred from a free form text field such as a summary of a user's experiences. Furthermore, while some portions of a user profile, such as an e-mail address, may be mandatory—that is, the online service may require the user to provide such information in order to register and establish an account—other portions of a user profile may be optional.

In the context of an online service, a variety of content-related and recommendation services utilize various aspects of a user's profile information—particularly skills—for targeting users to receive various content and for generating recommendations. For example, a content selection and ranking algorithm associated with a news feed, which may be referred to as a content feed, or simply a feed, may select and/or rank content items for presentation in the user's personalized content feed based on the extent to which the subject matter of a content item matches the perceived interests of the user. Here, the user's perceived interests may be based at least in part on the skills that he or she has listed in his or her profile. Similarly, a job-related search engine and/or recommendation service may select and/or rank job postings for presentation to a user based in part on skills listed in a profile of the user. Finally, a recommendation service for online courses may generate course recommendations for a user based at least in part on the skills that the user lists in his or her profile.

A knowledge graph may be used to represent relationships between entities based on certain attributes of the entities, such as skills associated with those entities. However, simply comparing skills between entities often results in inaccurate content being provided to users of an online service, since entities may be incorrectly associated certain skills and knowledge graphs may fail to connect entities that have similar but distinct skills. As a result, the accuracy and effectiveness of the online service in performing its functions suffers.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating functional components of an online service, in accordance with an example embodiment.

FIG. 2 is a table including corresponding probability values of specialties given an entity, in accordance with an example embodiment.

FIG. 3 illustrates a graph data structure, in accordance with an example embodiment.

FIG. 4 illustrates a graphical user interface (GUI) in which a user may add one or more specialties to a profile of the user, in accordance with an example embodiment.

FIG. 5 illustrates a GUI in which indications of other users with whom a first user is recommended to connect are displayed, in accordance with an example embodiment.

FIG. 6 illustrates a GUI in which online job postings are displayed, in accordance with an example embodiment.

FIG. 7 illustrates a GUI in which online courses are displayed, in accordance with an example embodiment.

FIG. 8 is a flowchart illustrating a method of predicting specialty data, in accordance with an example embodiment.

FIG. 9 is a flowchart illustrating another method of predicting specialty data, in accordance with an example embodiment.

FIG. 10 is a block diagram illustrating a software architecture, in accordance with an example embodiment.

FIG. 11 illustrates a diagrammatic representation of a machine in the form of a computer system within which a set of instructions may be executed for causing the machine to perform any one or more of the methodologies discussed herein, in accordance with an example embodiment.

### DETAILED DESCRIPTION

### I. Overview

Example methods and systems of predicting specialty data for a knowledge base using a machine learning model are disclosed. In the following description, for purposes of explanation, numerous specific details are set forth in order to provide a thorough understanding of example embodiments. It will be evident, however, to one skilled in the art that the present embodiments may be practiced without these specific details.

The above-discussed technical problems of accuracy and effectiveness are addressed by one or more example embodiments disclosed herein, in which a specially-configured computer system is configured to use machine learning models along with the law of total probability to predict which specialties apply to an entity based on a skill-to-specialty distribution skill-to-specialty distribution for a plurality of specialties given each skill in a plurality of skills and a user-to-skill distribution for the plurality of skills given the entity. A specialty is a pursuit, area of study, or skill to which a user has devoted much time and effort and in which they are expert. While specialties may include skills, not all skills are specialties. For example, “Accounting” may be both a skill and a specialty, but not every skill that falls within the category of or is otherwise related to “Accounting” is necessarily a specialty. In some example embodiments, specialties are a subset of skills. For example, the online service may manage a list of 40,000 skills, and only 1,400 of 40,000 skills may be identified and treated by the online service as specialties. The online service may store each skill in a database, and each skill in the database may have a field associated with it that identifies whether or not the skill is also a specialty. Additionally, each skill that is not identified as a specialty may be treated as falling within one or more specialties. For example, each skill in that is not identified as a specialty may have a field associated with it in the database that identifies one or more specialties within which the skill falls, such that each specialty represents a general skill within which other skills fall. The online service may use other techniques for managing a list of skills and a list of specialties as well.

An online service may store a predefined set of skills with which a profile of a user may be associated by the online service, and may also store a predefined set of specialties with which a profile of a user may be associated by the online service. For example, the online service may provide user interface elements with which the user may interact to select skills to be added to the profile of the user. Similarly, the online service may provide user interface elements with which the user may interact to select specialties to be added to the profile of the user. Alternatively, in some example embodiments, the online service may not provide the user with the ability to select specialties to the profile of the user. As a result of the user lacking the knowledge of what specialties should be added to the profile of the user or the online service not providing the functionality to allow the user to add specialties to the profile of the user, the online service may be deprived of specialty data for the user, thereby limiting the accuracy and effectiveness of the online service in performing its functions. However, in accordance with example embodiments of the present disclosure, a computer system may be configured to use machine learning modelmachine learning models along with the law of total probability to predict which specialties apply to the user or to some other type of entity (e.g., which specialties apply to a job posting).

By predicting specialties for entities, the computer system of the present disclosure can overcome noisy data resulting from skills being incorrectly associated with users or other entities. Additionally, specialties provide an effective tool for associating two entities that have similar, but distinct skills. In one example where the only skill included in the profile of user A is Random Forest and the only skill included in the profile of user B is Bayesian Networks, the computer system may determine that both user A and user B have a specialty of Machine Learning in common, thereby creating an association between user A and user B, even though their skills are distinct.

In some example embodiments, the computer system, for each skill in a plurality of skills, computes a skill-to-specialty distribution for a plurality of specialties using a first machine learning modelmachine learning model, where the skill-to-specialty distribution comprises a corresponding skill-to-specialty probability value for each specialty in the plurality of specialties given the skill in the plurality of skills. The computer system may also, for each skill in the plurality of skills, compute a user-to-skill distribution for the plurality of skills based on feature data of a first user of an online service using a second machine learning model, where the user-to-skill distribution comprises a corresponding user-to-skill probability value for each skill in the plurality of skills given the first user. Next, the computer system may compute a user-to-specialty distribution for the plurality of specialties based on the skill-to-specialty distribution and the user-to-skill distribution, where the user-to-specialty distribution comprises a corresponding user-to-specialty probability value for each specialty in the plurality of specialties given the first user. The computer system may then use the user-to-specialty distribution in an application of the online service.

### II. Detailed Example Embodiments

The methods or embodiments disclosed herein may be implemented as a computer system having one or more components implemented in hardware or software. For example, the methods or embodiments disclosed herein may be embodied as instructions stored on a machine-readable medium that, when executed by one or more hardware processors, cause the one or more hardware processors to perform the instructions.

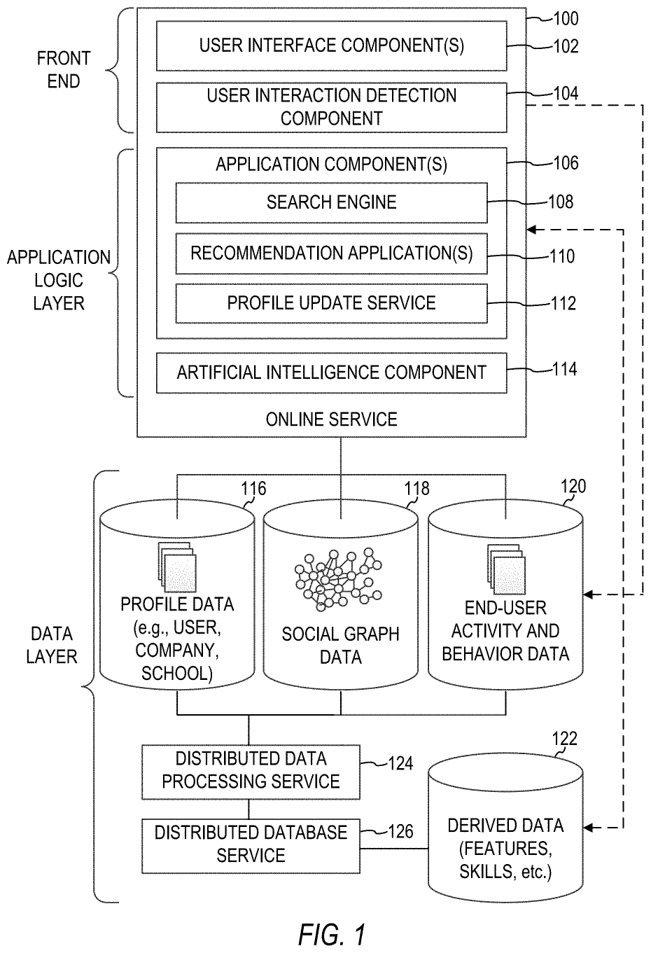

FIG. 1 is a block diagram illustrating functional components of an online service 100, in accordance with an example embodiment. As shown in FIG. 1, a front end may comprise one or more user interface components (e.g., a web server) 102, which receives requests from various client computing devices and communicates appropriate responses to the requesting client devices. For example, the user interface component(s) 102 may receive requests in the form of Hypertext Transfer Protocol (HTTP) requests or other web-based API requests. In addition, a user interaction detection component 104, sometimes referred to as a click tracking service, may be provided to detect various interactions that end-users have with different applications and services, such as those included in the application logic layer of the online service 100. As shown in FIG. 1, upon detecting a particular interaction, the user interaction detection component 104 logs the interaction, including the type of interaction and any metadata relating to the interaction, in an end-user activity and behavior database 120. Accordingly, data from this database 120 can be further processed to generate data appropriate for training one or more machine-learned models.

An application logic layer may include one or more application server components 106, which, in conjunction with the user interface component(s) 102, generate various user interfaces (e.g., web pages) with data retrieved from various data sources in a data layer. Consistent with some embodiments, individual application server components 106 implement the functionality associated with various applications and/or services provided by the online service 100. For instance, as illustrated in FIG. 1, the application logic layer includes a variety of applications and services to include a search engine 108, one or more recommendation applications 110 (e.g., a job recommendation application, an online course recommendation application), and a profile update service 112. The various applications and services illustrated as part of the application logic layer are provided as examples and are not meant to be an exhaustive listing of all applications and services that may be integrated with and provided as part of the online service 100. For example, although not shown in FIG. 1, the online service 100 may also include a job hosting service via which end-users submit job postings that can be searched by end-users, and/or recommended to other end-users by the recommendation application(s) 110. As end-users interact with the various user interfaces and content items presented by these applications and services, the user interaction detection component 104 detects and tracks the end-user interactions, logging relevant information for subsequent use.

As shown in FIG. 1, the data layer may include several databases, such as a profile database 116 for storing profile data, including both end-user profile data and profile data for various organizations (e.g., companies, schools, etc.). Consistent with some embodiments, when a person initially registers to become an end-user of the online service, the person will be prompted by the profile update service 114 to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 116. Similarly, when a representative of an organization initially registers the organization with the online service 100, the representative may be prompted to provide certain information about the organization. This information may be stored, for example, in the profile database 116, or another database (not shown).

Once registered, an end-user may invite other end-users, or be invited by other end-users, to connect via the online service 100. A “connection” may constitute a bilateral agreement by the end-users, such that both end-users acknowledge the establishment of the connection. Similarly, with some embodiments, an end-user may elect to “follow” another end-user. In contrast to establishing a connection, the concept of “following” another end-user typically is a unilateral operation and, at least with some embodiments, does not require acknowledgement or approval by the end-user that is being followed. When one end-user follows another, the end-user may receive status updates relating to the other end-user, or other content items published or shared by the other end-user user who is being followed. Similarly, when an end-user follows an organization, the end-user becomes eligible to receive status updates relating to the organization as well as content items published by, or on behalf of, the organization. For instance, content items published on behalf of an organization that an end-user is following will appear in the end-user's personalized feed, sometimes referred to as a content feed or news feed. In any case, the various associations and relationships that the end-users establish with other end-users, or with other entities (e.g., companies, schools, organization) and objects (e.g., metadata hashtags (“#topic”) used to tag content items), are stored and maintained within a social graph in a social graph database 118.

As end-users interact with the various content items that are presented via the applications and services of the online service 100, the end-users' interactions and behaviors (e.g., content viewed, links or buttons selected, messages responded to, job postings viewed, etc.) are tracked by the user interaction detection component 104, and information concerning the end-users' activities and behaviors may be logged or stored, for example, as indicated in FIG. 1 by the end-user activity and behavior database 120.

Consistent with some embodiments, data stored in the various databases of the data layer may be accessed by one or more software agents or applications executing as part of a distributed data processing service 124, which may process the data to generate derived data. The distributed data processing service 124 may be implemented using Apache Hadoop® or some other software framework for the processing of extremely large data sets. Accordingly, an end-user's profile data and any other data from the data layer may be processed (e.g., in the background or offline) by the distributed data processing service 124 to generate various derived profile data. As an example, if an end-user has provided information about various job titles that the end-user has held with the same organization or different organizations, and for how long, this profile information can be used to infer or derive an end-user profile attribute indicating the end-user's overall seniority level or seniority level within a particular organization. This derived data may be stored as part of the end-user's profile or may be written to another database.

In addition to generating derived attributes for end-users' profiles, one or more software agents or applications executing as part of the distributed data processing service 124 may ingest and process data from the data layer for the purpose of generating training data for use in training various machine-learned models, and for use in generating features for use as input to the trained models. For instance, profile data, social graph data, and end-user activity and behavior data, as stored in the databases of the data layer, may be ingested by the distributed data processing service 124 and processed to generate data properly formatted for use as training data for training one of the aforementioned machine-learned models for ranking skills. Similarly, the data may be processed for the purpose of generating features for use as input to the machine-learned models when ranking skills for a particular end-user. Once the derived data and features are generated, they are stored in a database 122, where such data can easily be accessed via calls to a distributed database service 124.

In some example embodiments, the application logic layer of the online service 100 also comprises an artificial intelligence component 114 that is configured to train and use one or more machine learning models to compute scores for specialties, and then use the computed scores in one or more application server components 106 of the online service 100. For example, the computed scores may be used by the search engine 108, the recommendation application(s) 110, or the profile update service 112, as will be discussed in further detail below.

In some example embodiments, the artificial intelligence component 114 is configured to train, using a supervised machine learning algorithm, a first machine learning model to output a skill-to-specialty probability value for a specialty when a skill is fed as input into the first machine learning model. Examples of supervised machine learning algorithms that may be used by the online service 100 to train the first machine learning model include, but are not limited to, linear regression, logistic regression, Naïve Bayes, decision trees, K-nearest neighbor, and similarity learning. The artificial intelligence component 114 may train the first machine learning model using training data comprising different combinations of skills and specialties. The training data may include different examples of a specific specialty applying to an entity given that a specific skill applies to the entity. These examples may be referred to as “skill-to-specialty” pairs. For example, the training data may include a first skill-to-specialty pair (Machine Learning, Artificial Neural Networks) in which “Machine Learning” applies to an entity when “Artificial Neural Networks” applies to the entity, and a second skill-to-specialty pair (Machine Learning, Random Forest) in which “Machine Learning” applies to an entity when “Random Forest” applies to the entity. In some example embodiments, logistic regression is used as the supervised machine learning algorithm, as the inventors have found through experimentation that logistic regression is very effective in avoiding overfitting when training the first machine learning model, especially when using a small set of training data, such as just a few hundred skill-to-specialty pairs in the training data. By using logistic regression, the artificial intelligence component 114 is able to train the first machine learning model quickly, since it can use a very small set of training data, while still training the first machine learning model to produce accurate computations, thereby optimizing speed and accuracy. Other types of supervised machine learning algorithms are also within the scope of the present disclosure.

In some example embodiments, the artificial intelligence component 114 is configured to, for each skill in a plurality of skills, compute a skill-to-specialty distribution for a plurality of specialties using the first machine learning model. The skill-to-specialty distribution may comprise a corresponding skill-to-specialty probability value for each specialty in the plurality of specialties given the skill in the plurality of skills. For example, given a plurality of skills {skil₁, skill₂, . . . , skill_{N}} and a plurality of specialties {specialty₁, specialty₂, . . . , specialty_{N}}, the artificial intelligence component 114 may compute the following skill-to-specialty probability values: P(specialty₁|skill₁), P(specialty₂|skill₁), P(specialty_{N}|skill₁), . . . , P(specialty₁|skill₂), P(specialty₂|skill₂), . . . , P(specialty_{N}|skill₂), . . . , P(specialty₁|skill_{N}), P(specialty₂|skill_{N}), . . . , P(specialty_{N}|skill_{N}).

In some example embodiments, the artificial intelligence component 114 is configured to, for each skill in the plurality of skills, compute a user-to-skill distribution for the plurality of skills based on feature data of a first user of the online service 100 using a second machine learning model. The user-to-skill distribution may comprise a corresponding user-to-skill probability value for each skill in the plurality of skills given the first user. For example, given a first user {users}, the artificial intelligence component 114 may compute the following user-to-skill probability values: P(skill₁ users), P(skill₂|user₁), . . . , P(skill_{N}|user₁). The feature data of the first user may comprise profile data extracted from a profile of the first user stored on the online service 100, such as the profile data stored in the database 116 in FIG. 1. For example, the profile data may include, but is not limited to, the first user's educational background, job history, and/or experiences, as well as individual skills possessed by the first user. The feature data of the first user may additionally or alternatively comprise interaction data indicating online content with which the first user has interacted with by performing an online action directed towards the online content via the online service 100, such as the data stored in the database 120 in FIG. 1. For example, the interaction data may include, but is not limited to, content viewed by the first user, links or buttons selected by the first user, messages responded to by the first user, job postings viewed by the first user, job postings applied to by the first user, and online courses viewed by the first user.

In some example embodiments, the artificial intelligence component 114 is configured to compute a user-to-specialty distribution for the plurality of specialties based on the skill-to-specialty distribution and the user-to-skill distribution. The user-to-specialty distribution may comprise a corresponding user-to-specialty probability value for each specialty in the plurality of specialties given the first user. For example, the artificial intelligence component 114 may compute the following third probability values: P(specialty₁|user₁), P(specialty₂|user₁), . . . , P(specialty_{N}|user₁). In some example embodiments, the artificial intelligence component 114 uses the following law of total probability to compute the user-to-specialty probability values:

P(specialty|user)=ΣP(skill|user)*P(specialty skill).

The artificial intelligence component 114 may use the law of total probability to compute the probability values for specialties given any type of entity:

P(specialty entity)=ΣP(skill entity)*P(specialty skill).

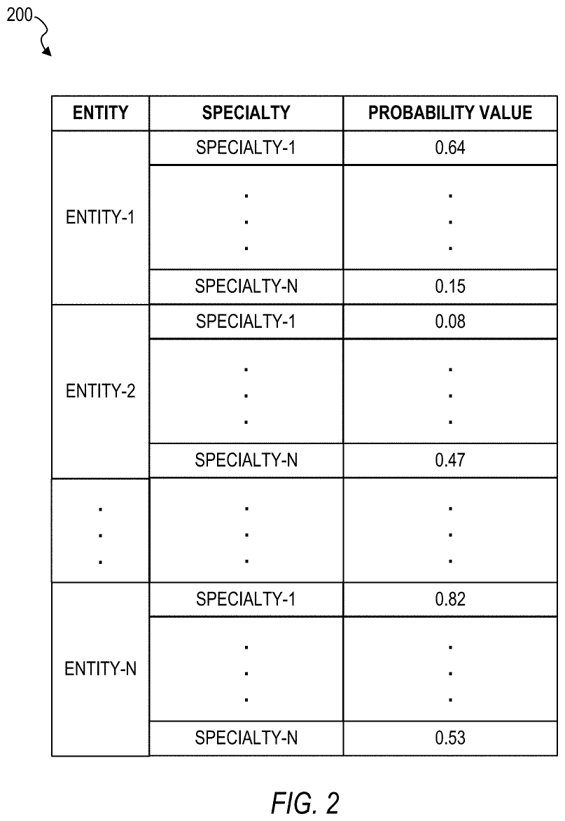

Examples of entities other than users include, but are not limited to, online job postings, online courses, advertisements, and other content items that are selected for display to a user of the online service 100. FIG. 2 is a table 200 including corresponding probability values of specialties given an entity, in accordance with an example embodiment. In FIG. 2, the table 200 comprises corresponding probability distributions for a plurality of entities (entity-1, entity-2, . . . , entity-N) given a plurality of specialties (specialty-1, specialty-2, . . . , specialty-N). For example, the table 200 shows that the probability of specialty-N applying to entity-2 (e.g., entity-2 having specialty-N or specialty-N being otherwise relevant to entity-2) is 0.47, which is much greater than the probability of specialty-1 applying to entity-2, which is 0.08. In one specific example, entity-2 is a user, specialty-1 is Accounting, and specialty-N is Machine Learning. In this specific example, based on the probability values in the table 200, the specialty of Machine Learning is much more likely to apply to the user than the specialty of Accounting, since the probability value of Machine Learning for the user is 0.47 and the probability value of Accounting is 0.08. Other entities, specialties, and probability values are also within the scope of the present disclosure. These probability values in table 200 may be stored in a database of the online service 100, such as part of the database 122.

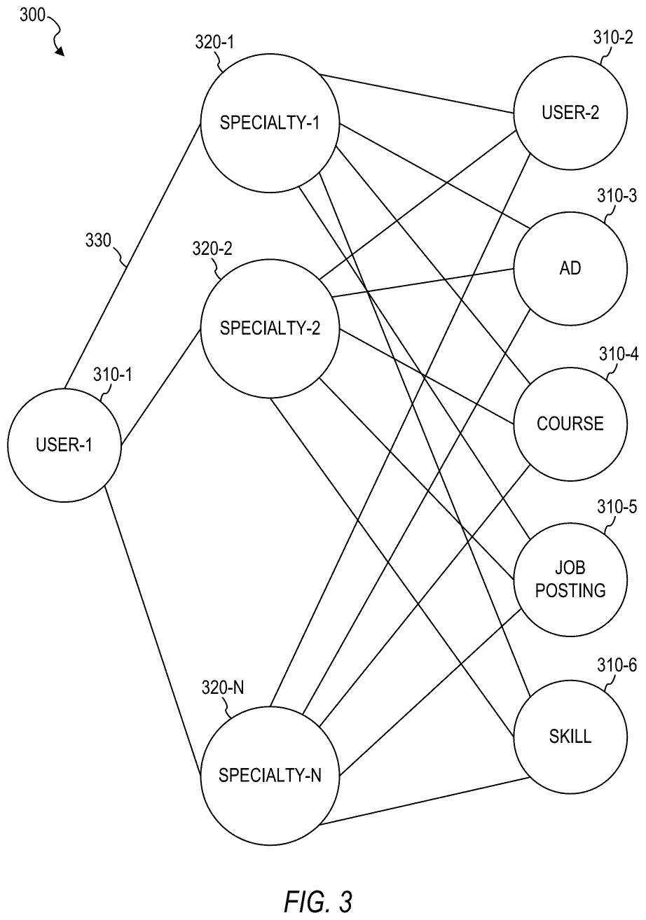

In some example embodiments, the artificial intelligence component 114 is configured to generate a graph data structure using the user-to-specialty distribution. FIG. 3 illustrates a graph data structure 300, in accordance with an example embodiment. The graph data structure 300 comprises a plurality of entity nodes 310 and a plurality of specialty nodes 320, with each one of the plurality of entity nodes corresponding to a different entity, and each one of the plurality of specialty nodes corresponding to a different specialty. In the example shown in FIG. 3, the plurality of entity nodes 310 comprises entity node 310-1 corresponding to a first user (user-1), entity node 310-2 corresponding to a second user (user-2), entity node 310-3 corresponding to an advertisement, entity node 310-4 corresponding to an online course, entity node 310-5 corresponding to an online job posting, and entity node 310-6 corresponding to a skill, while the specialty nodes 320 may comprise specialty node 320-1 corresponding to software development, specialty node 320-2 corresponding to data mining, and so on and so forth. Other types, quantities, and configurations of the entity nodes 310 and the specialty nodes 320 in the graph data structure 300 are also within the scope of the present disclosure.

In some example embodiments, each one of the plurality of specialty nodes 310 is connected to each one of the plurality of specialty nodes 320 by a corresponding edge 330 that indicates a probability value of the specialty corresponding to the specialty node 320 given the entity corresponding to the entity node 310. For each connection between an entity node and a specialty node, the artificial intelligence component 114 may have established the connection based on the user-to-specialty probability value of specialty corresponding to the specialty node 320 for the given entity corresponding to the entity node 310 being equal to or greater than a predetermined threshold value.

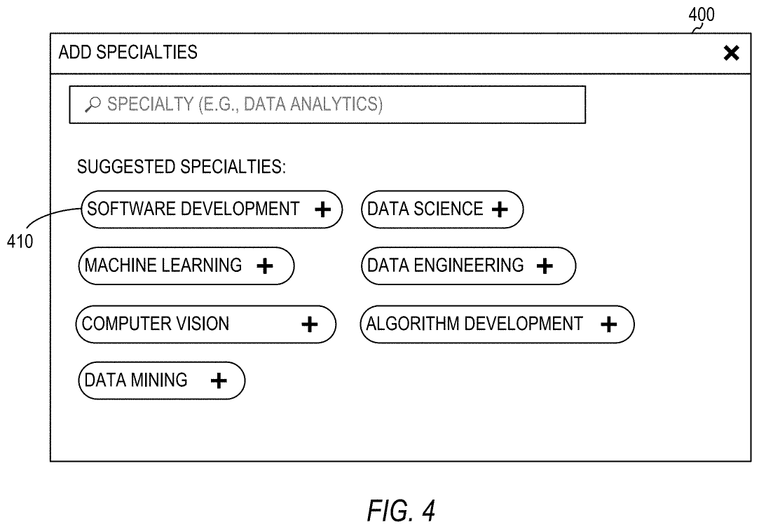

In some example embodiments, the online service 100 is configured to use the user-to-specialty distribution in one or more application components 106 of the online service 100. For example, the profile update service 112 may use the user-to-specialty distribution to determine which specialties to present to the user as a recommendation to add to his or her profile on the online service 100. The update profile service 112 may select one or more specialties from the plurality of specialties based on the corresponding user-to-specialty probability value for each one of the one or more specialties. For example, the update profile service 112 may select the specialties having a corresponding user-to-specialty probability value that is equal to or exceeds a predetermined threshold value. Alternatively, the update profile service 112 may rank the specialties based on their corresponding user-to-specialty probability values, and then select a portion of the specialties based on the ranking, such as by selecting the top N ranked specialties (e.g., the top ten ranked specialties). FIG. 4 illustrates a graphical user interface (GUI) 400 in which a user may add one or more specialties to a profile of the user, in accordance with an example embodiment. In some example embodiments, the update profile service 112 displays a corresponding selectable user interface element 410 for each one of the selected one or more specialties on a computing device of the first user. The corresponding selectable user interface element 410 may be configured to trigger storing of the corresponding specialty as part of a profile of the first user in response to a selection of the corresponding selectable user interface element 410.

In addition to computing a probability distribution of specialties for the first user, the artificial intelligence component 114 may also compute a probability distribution of specialties for other entities as well, such as for other users different from the first user, job postings, and online courses. For each type of entity, the artificial intelligence component 114 may use a different machine learning model that corresponds to that type of entity to compute a probability distribution of skills for that type of entity. For example, while the artificial intelligence component 114 may use the second machine learning model to compute a probability distribution for skills for other users that are different from the first user, since the other users are of the same type of entity as the first user, the artificial intelligence component 114 may use a third machine learning model that is different from the second machine learning model to compute a probability distribution of skills for another type of entity, such as for job postings or online courses. For example, for other types of entities other than users, the artificial intelligence component 114 may, for each skill in the plurality of skills, compute an entity-to-skill distribution for the plurality of skills based on feature data of that other entity of the online service 100 using a third machine learning model. The entity-to-skill distribution may comprise a corresponding entity-to-skill probability value for each skill in the plurality of skills given the entity. The artificial intelligence component 114 may then compute a entity-to-specialty probability distribution for the plurality of specialties based on the skill-to-specialty distribution and the entity-to-skill distribution. In some example embodiments, the entity-to-specialty probability distribution comprises a corresponding entity-to-specialty probability value for each specialty in the plurality of specialties given the entity. The entity-to-specialty probability distribution may then be stored in the table 200 and used to generate the graph data structure 300. The entity-to-specialty probability distribution may be computed for every entity of the online service 100, thereby resulting in a knowledge graph that can be used to determine what specialties apply to or are otherwise relevant to any given entity, as well as to determine relationships between entities based on the respective probabilities that specialties apply to or are otherwise relevant to them.

In some example embodiments, the entity comprises a second user different from the first user. In such embodiments, using the user-to-specialty distribution and the entity-to-specialty probability distribution in the application of the online service 100 may comprise, based on the user-to-specialty distribution and the entity-to-specialty probability distribution, displaying a corresponding selectable user interface element in association with an indication of the second user on a computing device of the first user. For example, one of the recommendation applications 110 may generate a first embedding vector based on the user-to-specialty distribution and a second embedding vector for the entity-to-specialty probability distribution, and then compare the first embedding vector with the second embedding vector to determine whether the second user is sufficiently relevant or similar to the first user. The recommendation application 110 may compute a cosine similarity measurement based on the first embedding vector and the second embedding vector, and then determine whether the cosine similarity measurement is equal to or greater than a threshold value. The recommendation application 110 may then display the corresponding selectable user interface element in association with the indication of the second user on the computing device of the first user in response to or otherwise based on the determination that the cosine similarity measurement is equal to or is greater than the threshold value. The corresponding selectable user interface element may be configured to trigger, in response to its selection, a transmission of an invitation to connect from the first user to the second user.

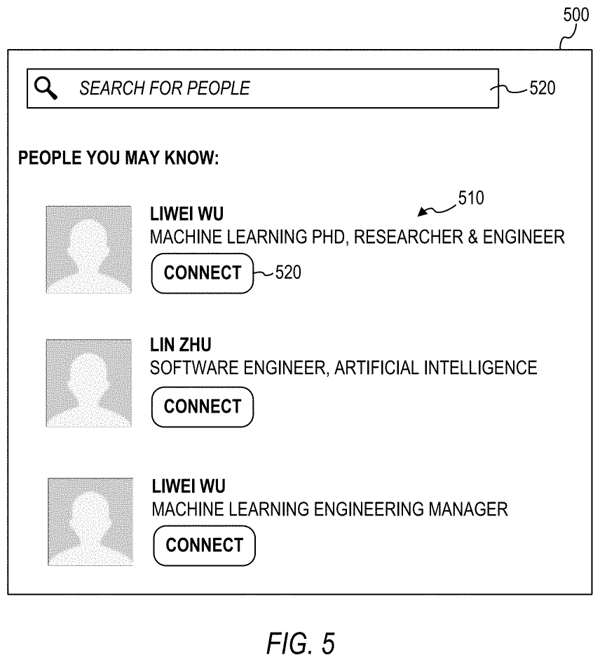

FIG. 5 illustrates a GUI 500 in which indications 510 of other users with whom a first user is recommended to connect are displayed, in accordance with an example embodiment. The recommendation application 110 may cause the GUI 500 to display each indication 510 along with a corresponding selectable user interface element 520 may be configured to trigger, in response to its selection, a transmission of an invitation to connect from the first user to the other user. The GUI 500 may also include a search field 520 configured to receive a search query from the first user. In response to the search query, the search engine 108 may generate search results for the search query using the user-to-specialty distribution of the first user.

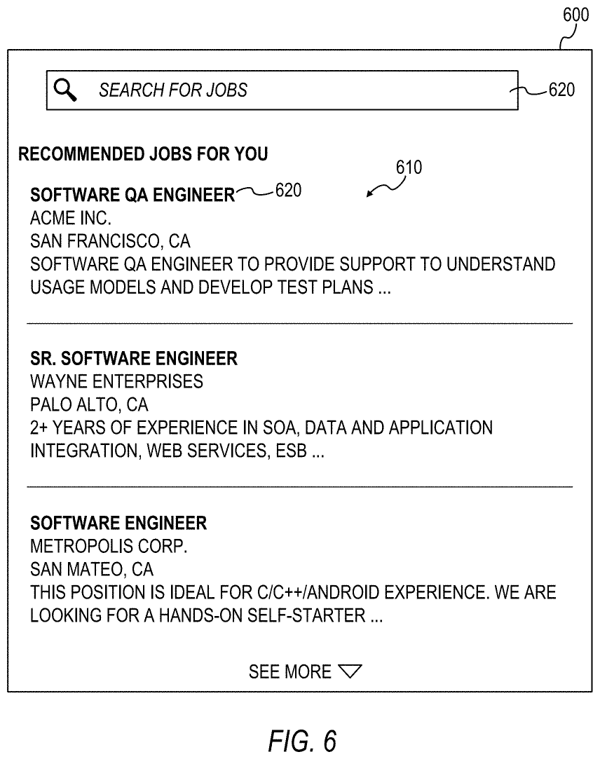

The recommendation application(s) 110 may comprise a job recommendation application configured to generate and display recommendations of online job postings for the first user. FIG. 6 illustrates a GUI 600 in which online job postings are displayed, in accordance with an example embodiment. In some example embodiments, the recommendation application 110 displays a corresponding selectable user interface element 620 in association with an indication 610 of the online job posting on a computing device of the first user. The recommendation application 110 may generate a first embedding vector based on the user-to-specialty distribution and a second embedding vector for the entity-to-specialty probability distribution, and then compare the first embedding vector with the second embedding vector to determine whether the online job posting is sufficiently relevant to the first user. For example, the recommendation application 110 may compute a cosine similarity measurement based on the first embedding vector and the second embedding vector, and then determine whether the cosine similarity measurement is equal to or greater than a threshold value. The recommendation application 110 may then display the corresponding selectable user interface element 620 in association with the indication 610 of the online job posting on the computing device of the first user in response to or otherwise based on the determination that the cosine similarity measurement is equal to or is greater than the threshold value. The corresponding selectable user interface element 620 may be configured to, in response to its selection, trigger a display of the online job posting on the computing device of the first user or initiate an online application process for the online job posting on the computing device of the first user. The GUI 600 may also include a search field 620 configured to receive a search query from the first user. In response to the search query, the search engine 108 may generate search results for the search query using the user-to-specialty distribution of the first user.

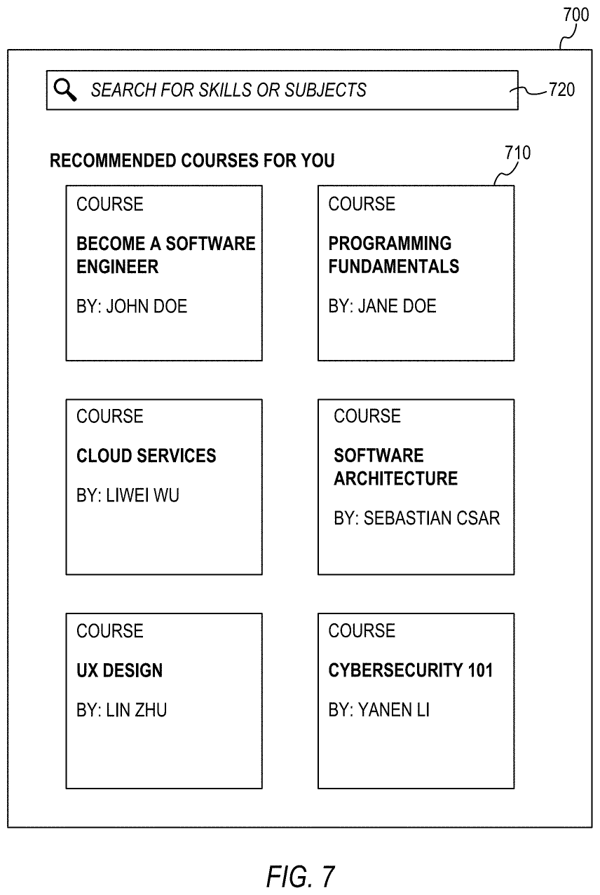

In some example embodiments, the recommendation application(s) 110 comprise a course recommendation application configured to generate and display recommendations of online courses for the first user. FIG. 7 illustrates a GUI 700 in which online courses are displayed, in accordance with an example embodiment. The recommendation application 110 may, based on the user-to-specialty distribution and the entity-to-specialty probability distribution, display a corresponding selectable user interface element 710 in association with an indication of the online course on a computing device of the first user. The recommendation application 110 may generate a first embedding vector based on the user-to-specialty distribution and a second embedding vector for the entity-to-specialty probability distribution, and then compare the first embedding vector with the second embedding vector to determine whether the online course is sufficiently relevant to the first user. For example, the recommendation application 110 may compute a cosine similarity measurement based on the first embedding vector and the second embedding vector, and then determine whether the cosine similarity measurement is equal to or greater than a threshold value. The recommendation application 110 may then display the corresponding selectable user interface element 710 in association with the indication of the online course on the computing device of the first user in response to or otherwise based on the determination that the cosine similarity measurement is equal to or is greater than the threshold value. The corresponding selectable user interface element 710 may be configured to, in response to its selection, trigger an online process for playing the online course on the computing device of the first user. The GUI 700 may also include a search field 720 configured to receive a search query from the first user. In response to the search query, the search engine 108 may generate search results for the search query using the user-to-specialty distribution of the first user.

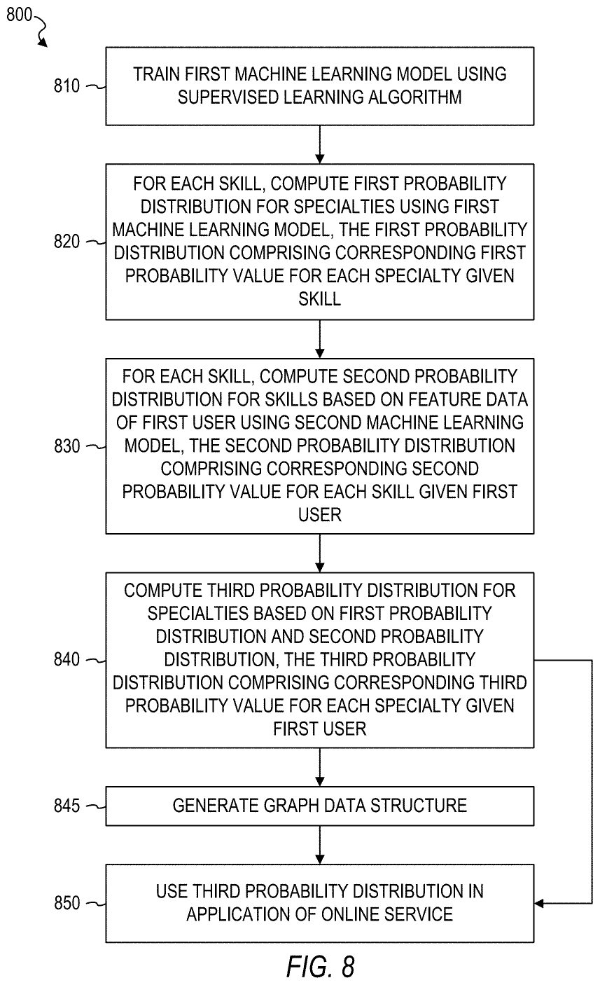

FIG. 8 is a flowchart illustrating a method 800 of predicting specialty data, in accordance with an example embodiment. The method 800 can be performed by processing logic that can comprise hardware (e.g., circuitry, dedicated logic, programmable logic, microcode, etc.), software (e.g., instructions run on a processing device), or a combination thereof. In one implementation, the method 800 is performed by the online service 100 of FIG. 1, or any combination of one or more of its components (e.g., the artificial intelligence component 114, the application component 106), as described above.

At operation 810, the online service 100 trains a first machine learning model using a supervised machine learning algorithm. Examples of supervised machine learning algorithms that may be used by the online service 100 to train the first machine learning model include, but are not limited to, linear regression, logistic regression, Naïve Bayes, decision trees, K-nearest neighbor, and similarity learning. In some example embodiments, logistic regression is used as the supervised machine learning algorithm, as the inventors have found through experimentation that logistic regression is very effective in avoiding overfitting when training the first machine learning model. Other types of supervised machine learning algorithms are also within the scope of the present disclosure.

At operation 820, the online service 100, for each skill in a plurality of skills, computes a skill-to-specialty distribution for a plurality of specialties using the first machine learning model. In some example embodiments, the skill-to-specialty distribution comprises a corresponding skill-to-specialty probability value for each specialty in the plurality of specialties given the skill in the plurality of skills.

At operation 830, the online service 100, for each skill in the plurality of skills, computes a user-to-skill distribution for the plurality of skills based on feature data of a first user of an online service using a second machine learning model. In some example embodiments, the user-to-skill distribution comprises a corresponding user-to-skill probability value for each skill in the plurality of skills given the first user. The feature data of the first user may comprise profile data extracted from a profile of the first user stored on the online service. The feature data of the first user may additionally or alternatively comprise interaction data indicating online content with which the first user has interacted with by performing an online action directed towards the online content via the online service.

At operation 840, the online service 100 computes a user-to-specialty distribution for the plurality of specialties based on the skill-to-specialty distribution and the user-to-skill distribution. In some example embodiments, the user-to-specialty distribution comprises a corresponding user-to-specialty probability value for each specialty in the plurality of specialties given the first user.

At operation 850, the online service 100 uses the user-to-specialty distribution in an application of the online service. In some example embodiments, the online service 100 selects one or more specialties from the plurality of specialties based on the corresponding user-to-specialty probability value for each one of the one or more specialties. For example, the online service 100 may select the specialties having a corresponding user-to-specialty probability value that is equal to or exceeds a predetermined threshold value. Alternatively, the online service 100 may rank the specialties based on their corresponding user-to-specialty probability values, and then select a portion of the specialties based on the ranking, such as by selecting the top N ranked specialties (e.g., the top ten ranked specialties). In some example embodiments, the online service 100 displays a corresponding selectable user interface element for each one of the selected one or more specialties on a computing device of the first user, such as discussed above with respect to FIG. 4. The corresponding selectable user interface element may be configured to trigger storing of the corresponding specialty as part of a profile of the first user in response to a selection of the corresponding selectable user interface element, and the profile may be stored on the online service.

In some example embodiments, after the computation of the user-to-specialty distribution at operation 840, the online service 100 generates a graph data structure using the user-to-specialty distribution. The generated graph data structure may comprise a plurality of entity nodes and a plurality of specialty nodes, with each one of the plurality of entity nodes corresponding to a different entity, each one of the plurality of specialty nodes corresponding to a different specialty, and each one of the plurality of specialty nodes being connected to each one of the plurality of specialty nodes by a corresponding edge that indicates a probability value of the specialty corresponding to the specialty node given the entity corresponding to the entity node. For example, the graph data structure may comprise the graph data structure 300 discussed above with respect to FIG. 3. In some example embodiments, for each connection between an entity node and a specialty node, the connection may be established based on the user-to-specialty probability value of specialty corresponding to the specialty node for the given entity corresponding to the entity node being equal to or greater than a predetermined threshold value. The graph data structure may be used in the application of the online service 100 at operation 850. For example, the online service 100 may access the graph data structure to determine specialty nodes.

It is contemplated that any of the other features described within the present disclosure can be incorporated into the method 800.

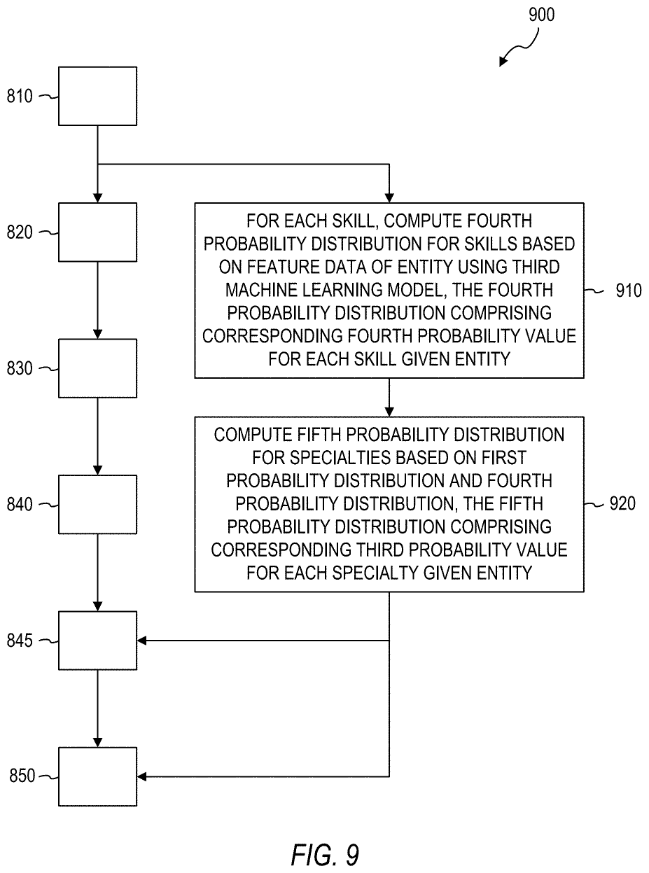

FIG. 9 is a flowchart illustrating another method 900 of predicting specialty data, in accordance with an example embodiment. The method 900 can be performed by processing logic that can comprise hardware (e.g., circuitry, dedicated logic, programmable logic, microcode, etc.), software (e.g., instructions run on a processing device), or a combination thereof. In one implementation, the method 900 is performed by the online service 100 of FIG. 1, or any combination of one or more of its components (e.g., the artificial intelligence component 114, the application component 106), as described above. The method 900 may include operations 910 and 920 being performed prior to operation 845 or operation 850 of the method 800 of FIG. 8.

In method 900, in addition to computing the user-to-specialty distribution for the plurality of specialties for the first user, the online service 100 also computes another probability distribution for the plurality of specialties for another entity that is different from the first user. Examples of other entities include, but are not limited to, other users that are different from the first user, job postings, and online courses.

At operation 910, the online service 100, for each skill in the plurality of skills, computes a entity-to-skill distribution for the plurality of skills based on feature data of an entity of the online service using a third machine learning model. In some example embodiments, the entity-to-skill distribution comprises a corresponding entity-to-skill probability valueentity-to-skill probability value for each skill in the plurality of skills given the entity.

At operation 920, the online service 100 computes a entity-to-specialty probability distribution for the plurality of specialties based on the skill-to-specialty distribution and the entity-to-skill distribution. In some example embodiments, the entity-to-specialty probability distribution comprises a corresponding entity-to-specialty probability value for each specialty in the plurality of specialties given the entity. The entity-to-specialty probability distribution may then be used to generate the graph data structure at operation 845 or in the application of the online service 100 at operation 850.

In some example embodiments, the entity comprises a second user different from the first user. In such embodiments, using the user-to-specialty distribution and the entity-to-specialty probability distribution in the application of the online service may comprise, based on the user-to-specialty distribution and the entity-to-specialty probability distribution, displaying a corresponding selectable user interface element in association with an indication of the second user on a computing device of the first user. The online service 100 may generate a first embedding vector based on the user-to-specialty distribution and a second embedding vector for the entity-to-specialty probability distribution, and then compare the first embedding vector with the second embedding vector to determine whether the second user is sufficiently relevant or similar to the first user. For example, the online service 100 may compute a cosine similarity measurement based on the first embedding vector and the second embedding vector, and then determine whether the cosine similarity measurement is equal to or greater than a threshold value. The online service 100 may then display the corresponding selectable user interface element in association with the indication of the second user on the computing device of the first user in response to or otherwise based on the determination that the cosine similarity measurement is equal to or is greater than the threshold value. The corresponding selectable user interface element may be configured to trigger, in response to its selection, a transmission of an invitation to connect from the first user to the second user, such as discussed above with FIG. 5.

In some example embodiments, the entity comprises an online job posting. In such embodiments, using the user-to-specialty distribution and the entity-to-specialty probability distribution in the application of the online service may comprise, based on the user-to-specialty distribution and the entity-to-specialty probability distribution, displaying a corresponding selectable user interface element in association with an indication of the online job posting on a computing device of the first user. The online service 100 may generate a first embedding vector based on the user-to-specialty distribution and a second embedding vector for the entity-to-specialty probability distribution, and then compare the first embedding vector with the second embedding vector to determine whether the online job posting is sufficiently relevant to the first user. For example, the online service 100 may compute a cosine similarity measurement based on the first embedding vector and the second embedding vector, and then determine whether the cosine similarity measurement is equal to or greater than a threshold value. The online service 100 may then display the corresponding selectable user interface element in association with the indication of the online job posting on the computing device of the first user in response to or otherwise based on the determination that the cosine similarity measurement is equal to or is greater than the threshold value. The corresponding selectable user interface element may be configured to, in response to its selection, trigger a display of the online job posting on the computing device of the first user or initiate an online application process for the online job posting on the computing device of the first user, such as discussed above with FIG. 6.

In some example embodiments, the entity comprises an online course. In such embodiments, using the user-to-specialty distribution and the entity-to-specialty probability distribution in the application of the online service may comprise, based on the user-to-specialty distribution and the entity-to-specialty probability distribution, displaying a corresponding selectable user interface element in association with an indication of the online course on a computing device of the first user. The online service 100 may generate a first embedding vector based on the user-to-specialty distribution and a second embedding vector for the entity-to-specialty probability distribution, and then compare the first embedding vector with the second embedding vector to determine whether the online course is sufficiently relevant to the first user. For example, the online service 100 may compute a cosine similarity measurement based on the first embedding vector and the second embedding vector, and then determine whether the cosine similarity measurement is equal to or greater than a threshold value. The online service 100 may then display the corresponding selectable user interface element in association with the indication of the online course on the computing device of the first user in response to or otherwise based on the determination that the cosine similarity measurement is equal to or is greater than the threshold value. The corresponding selectable user interface element may be configured to, in response to its selection, trigger an online process for playing the online course on the computing device of the first user, such as discussed above with FIG. 7.

It is contemplated that any of the other features described within the present disclosure can be incorporated into the method 900.

In view of the disclosure above, various examples are set forth below. It should be noted that one or more features of an example, taken in isolation or combination, should be considered within the disclosure of this application.

Example 1 includes a computer-implemented method performed by a computer system having a memory and at least one hardware processor, the computer-implemented method comprising: for each skill in a plurality of skills, computing a skill-to-specialty distribution for a plurality of specialties using a first machine learning model, the skill-to-specialty distribution comprising a skill-to-specialty probability value for each specialty in the plurality of specialties given the skill in the plurality of skills; for each skill in the plurality of skills, computing a user-to-skill distribution for the plurality of skills based on feature data of a first user of an online service using a second machine learning model, the user-to-skill distribution comprising a user-to-skill probability value for each skill in the plurality of skills given the first user; computing a user-to-specialty distribution for the plurality of specialties based on the skill-to-specialty distribution and the user-to-skill distribution, the user-to-specialty distribution comprising a user-to-specialty probability value for each specialty in the plurality of specialties given the first user; and using the user-to-specialty distribution in an application of the online service.

Example 2 includes the computer-implemented method of example 1, further comprising: generating a graph data structure using the user-to-specialty distribution, the generated graph data structure comprising a plurality of entity nodes and a plurality of specialty nodes, each one of the plurality of entity nodes corresponding to a different entity, each one of the plurality of specialty nodes corresponding to a different specialty, each one of the plurality of specialty nodes being connected to each one of the plurality of specialty nodes by an edge that indicates a probability value of the specialty corresponding to the specialty node given the entity corresponding to the entity node, wherein the using the user-to-specialty distribution in the application of the online service comprises using the graph data structure in the application of the online service.

Example 3 includes the computer-implemented method of example 1 or example 2, wherein the using the user-to-specialty distribution in the application of the online service comprises: selecting one or more specialties from the plurality of specialties based on the user-to-specialty probability value for each one of the one or more specialties; and displaying a selectable user interface element for each one of the selected one or more specialties on a computing device of the first user, the selectable user interface element being configured to trigger storing of the specialty as part of a profile of the first user in response to a selection of the selectable user interface element, the profile being stored on the online service.

Example 4 includes the computer-implemented method of example 1 or example 3, wherein the feature data of the first user comprises profile data extracted from a profile of the first user stored on the online service.

Example 5 includes the computer-implemented method of any one of examples 1 to 4, wherein the feature data of the first user comprises interaction data indicating online content with which the first user has interacted with by performing an online action directed towards the online content via the online service.

Example 6 includes the computer-implemented method of any one of examples 1 to 5, further comprising: for each skill in the plurality of skills, computing an entity-to-skill distribution for the plurality of skills based on feature data of an entity of the online service using a third machine learning model, the entity-to-skill distribution comprising a entity-to-skill probability valueentity-to-skill probability value for each skill in the plurality of skills given the entity; and computing an entity-to-specialty probability distribution for the plurality of specialties based on the skill-to-specialty distribution and the entity-to-skill distribution, the entity-to-specialty probability distribution comprising a entity-to-specialty probability value for each specialty in the plurality of specialties given the entity, wherein the using the user-to-specialty distribution in the application of the online service comprises using the user-to-specialty distribution and the entity-to-specialty probability distribution in the application of the online service.

Example 7 includes the computer-implemented method of any one of examples 1 to 6, wherein the entity comprises a second user different from the first user, and using the user-to-specialty distribution and the entity-to-specialty probability distribution in the application of the online service comprises: based on the user-to-specialty distribution and the entity-to-specialty probability distribution, displaying a selectable user interface element in association with an indication of the second user on a computing device of the first user, the selectable user interface element being configured to trigger, in response to its selection, a transmission of an invitation to connect from the first user to the second user.

Example 8 includes the computer-implemented method of any one of examples 1 to 7, wherein the entity comprises an online job posting, and using the user-to-specialty distribution and the entity-to-specialty probability distribution in the application of the online service comprises: based on the user-to-specialty distribution and the entity-to-specialty probability distribution, displaying a selectable user interface element in association with an indication of the online job posting on a computing device of the first user, the selectable user interface element being configured to, in response to its selection, trigger a display of the online job posting on the computing device of the first user or initiate an online application process for the online job posting on the computing device of the first user.

Example 9 includes the computer-implemented method of any one of examples 1 to 8, wherein the entity comprises an online course, and using the user-to-specialty distribution and the entity-to-specialty probability distribution in the application of the online service comprises: based on the user-to-specialty distribution and the entity-to-specialty probability distribution, displaying a selectable user interface element in association with an indication of the online course on a computing device of the first user, the selectable user interface element being configured to, in response to its selection, trigger an online process for playing the online course on the computing device of the first user.

Example 10 includes the computer-implemented method of any one of examples 1 to 9, further comprising training the first machine learning model using a supervised machine learning algorithm.

Example 11 includes a system comprising: at least one processor; and a non-transitory computer-readable medium storing executable instructions that, when executed, cause the at least one processor to perform the method of any one of examples 1 to 10.

Example 12 includes a non-transitory machine-readable storage medium, tangibly embodying a set of instructions that, when executed by at least one processor, causes the at least one processor to perform the method of any one of examples 1 to 10.

Example 13 includes a machine-readable medium carrying a set of instructions that, when executed by at least one processor, causes the at least one processor to carry out the method of any one of examples 1 to 10.

Example 14 includes a means for performing the method of any one of examples 1 to 10.

Certain embodiments are described herein as including logic or a number of components or mechanisms. Components may constitute either software components (e.g., code embodied (1) on a non-transitory machine-readable medium or (2) in a transmission signal) or hardware-implemented components. A hardware-implemented component is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented component that operates to perform certain operations as described herein.

In various embodiments, a hardware-implemented component may be implemented mechanically or electronically. For example, a hardware-implemented component may comprise dedicated circuitry or logic that is permanently configured (e.g., as a special-purpose processor, such as a field programmable gate array (FPGA) or an application-specific integrated circuit (ASIC)) to perform certain operations. A hardware-implemented component may also comprise programmable logic or circuitry (e.g., as encompassed within a programmable processor) that is temporarily configured by software to perform certain operations. It will be appreciated that the decision to implement a hardware-implemented component mechanically, in dedicated and permanently configured circuitry, or in temporarily configured circuitry (e.g., configured by software) may be driven by cost and time considerations.

Accordingly, the term “hardware-implemented component” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented components are temporarily configured (e.g., programmed), each of the hardware-implemented components need not be configured or instantiated at any one instance in time. For example, where the hardware-implemented components comprise a processor configured using software, the processor may be configured as respective different hardware-implemented components at different times. Software may accordingly configure a processor, for example, to constitute a particular hardware-implemented component at one instance of time and to constitute a different hardware-implemented component at a different instance of time.

Hardware-implemented components can provide information to, and receive information from, other hardware-implemented components. Accordingly, the described hardware-implemented components may be regarded as being communicatively coupled. Where multiple of such hardware-implemented components exist contemporaneously, communications may be achieved through signal transmission (e.g., over appropriate circuits and buses) that connect the hardware-implemented components. In embodiments in which multiple hardware-implemented components are configured or instantiated at different times, communications between such hardware-implemented components may be achieved, for example, through the storage and retrieval of information in memory structures to which the multiple hardware-implemented components have access. For example, one hardware-implemented component may perform an operation, and store the output of that operation in a memory device to which it is communicatively coupled. A further hardware-implemented component may then, at a later time, access the memory device to retrieve and process the stored output. Hardware-implemented components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Similarly, the methods described herein may be at least partially processor-implemented. For example, at least some of the operations of a method may be performed by one or more processors or processor-implemented components. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a component, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

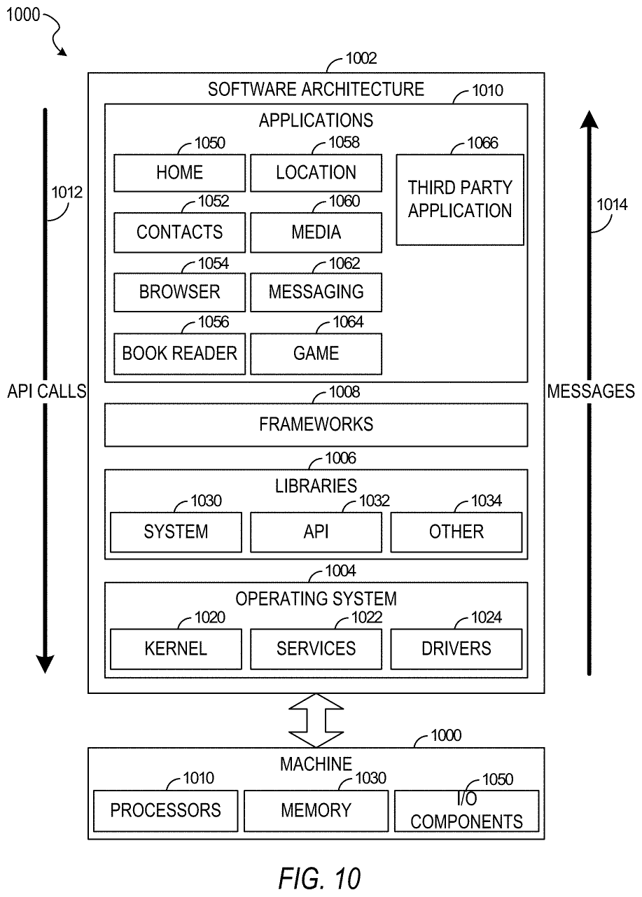

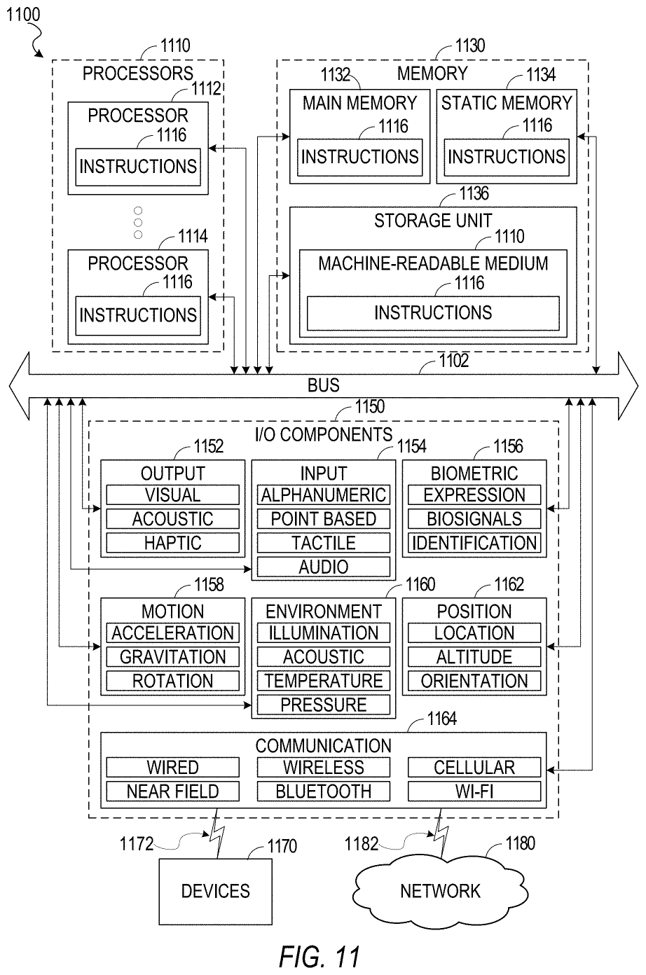

FIG. 10 is a block diagram 1000 illustrating a software architecture 1002, which can be installed on any one or more of the devices described above. FIG. 10 is merely a non-limiting example of a software architecture, and it will be appreciated that many other architectures can be implemented to facilitate the functionality described herein. In various embodiments, the software architecture 1002 is implemented by hardware such as a machine 1100 of FIG. 11 that includes processors 1010, memory 1030, and input/output (I/O) components 1050. In this example architecture, the software architecture 1002 can be conceptualized as a stack of layers where each layer may provide a particular functionality. For example, the software architecture 1002 includes layers such as an operating system 1004, libraries 1006, frameworks 1008, and applications 1010. Operationally, the applications 1010 invoke API calls 1012 through the software stack and receive messages 1014 in response to the API calls 1012, consistent with some embodiments.

In various implementations, the operating system 1004 manages hardware resources and provides common services. The operating system 1004 includes, for example, a kernel 1020, services 1022, and drivers 1024. The kernel 1020 acts as an abstraction layer between the hardware and the other software layers, consistent with some embodiments. For example, the kernel 1020 provides memory management, processor management (e.g., scheduling), component management, networking, and security settings, among other functionality. The services 1022 can provide other common services for the other software layers. The drivers 1024 are responsible for controlling or interfacing with the underlying hardware, according to some embodiments. For instance, the drivers 1024 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 1006 provide a low-level common infrastructure utilized by the applications 1010. The libraries 1006 can include system libraries 1030 (e.g., C standard library) that can provide functions such as memory allocation functions, string manipulation functions, mathematic functions, and the like. In addition, the libraries 1006 can include API libraries 1032 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 1006 can also include a wide variety of other libraries 1034 to provide many other APIs to the applications 1010.

The frameworks 1008 provide a high-level common infrastructure that can be utilized by the applications 1010, according to some embodiments. For example, the frameworks 1008 provide various GUI functions, high-level resource management, high-level location services, and so forth. The frameworks 1008 can provide a broad spectrum of other APIs that can be utilized by the applications 1010, some of which may be specific to a particular operating system 1004 or platform.

In an example embodiment, the applications 1010 include a home application 1050, a contacts application 1052, a browser application 1054, a book reader application 1056, a location application 1058, a media application 1060, a messaging application 1062, a game application 1064, and a broad assortment of other applications, such as a third-party application 1066. According to some embodiments, the applications 1010 are programs that execute functions defined in the programs. Various programming languages can be employed to create one or more of the applications 1010, structured in a variety of manners, such as object-oriented programming languages (e.g., Objective-C, Java, or C++) or procedural programming languages (e.g., C or assembly language). In a specific example, the third-party application 1066 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1066 can invoke the API calls 1012 provided by the operating system 1004 to facilitate functionality described herein.

FIG. 11 illustrates a diagrammatic representation of a machine 1100 in the form of a computer system within which a set of instructions may be executed for causing the machine 1100 to perform any one or more of the methodologies discussed herein, according to an example embodiment. Specifically, FIG. 11 shows a diagrammatic representation of the machine 1100 in the example form of a computer system, within which instructions 1116 (e.g., software, a program, an application 1110, an applet, an app, or other executable code) for causing the machine 1100 to perform any one or more of the methodologies discussed herein may be executed. For example, the instructions 1116 may cause the machine 1100 to execute the method 800 of FIG. 8 or the method 9 of FIG. 9. Additionally, or alternatively, the instructions 1116 may implement FIGS. 1-6, and so forth. The instructions 1116 transform the general, non-programmed machine 1100 into a particular machine 1100 programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a PC, a tablet computer, a laptop computer, a netbook, a set-top box (STB), a portable digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 may include processors 1110, memory 1130, and I/O components 1150, which may be configured to communicate with each other such as via a bus 1102. In an example embodiment, the processors 1110 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1112 and a processor 1114 that may execute the instructions 1116. The term “processor” is intended to include multi-core processors 1110 that may comprise two or more independent processors 1112 (sometimes referred to as “cores”) that may execute instructions 1116 contemporaneously. Although FIG. 11 shows multiple processors 1110, the machine 1100 may include a single processor 1112 with a single core, a single processor 1112 with multiple cores (e.g., a multi-core processor), multiple processors 1110 with a single core, multiple processors 1110 with multiple cores, or any combination thereof.

The memory 1130 may include a main memory 1132, a static memory 1134, and a storage unit 1136, all accessible to the processors 1110 such as via the bus 1102. The main memory 1132, the static memory 1134, and the storage unit 1136 store the instructions 1116 embodying any one or more of the methodologies or functions described herein. The instructions 1116 may also reside, completely or partially, within the main memory 1132, within the static memory 1134, within the storage unit 1136, within at least one of the processors 1110 (e.g., within the processor's cache memory), or any suitable combination thereof, during execution thereof by the machine 1100.

The I/O components 1150 may include a wide variety of components to receive input, provide output, produce output, transmit information, exchange information, capture measurements, and so on. The specific I/O components 1150 that are included in a particular machine 1100 will depend on the type of machine 1100. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion, and the grouping is in no way limiting. In various example embodiments, the I/O components 1150 may include output components 1152 and input components 1154. The output components 1152 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1150 may include biometric components 1156, motion components 1158, environmental components 1160, or position components 1162, among a wide array of other components. For example, the biometric components 1156 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1162 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via a coupling 1182 and a coupling 1172, respectively. For example, the communication components 1164 may include a network interface component or another suitable device to interface with the network 1180. In further examples, the communication components 1164 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., a peripheral device coupled via a USB).

Moreover, the communication components 1164 may detect identifiers or include components operable to detect identifiers. For example, the communication components 1164 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1164, such as location via Internet Protocol (IP) geolocation, location via Wi-Fi® signal triangulation, location via detecting an NFC beacon signal that may indicate a particular location, and so forth.

The various memories (i.e., 1130, 1132, 1134, and/or memory of the processor(s) 1110) and/or the storage unit 1136 may store one or more sets of instructions 1116 and data structures (e.g., software) embodying or utilized by any one or more of the methodologies or functions described herein. These instructions (e.g., the instructions 1116), when executed by the processor(s) 1110, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 1116 and/or data. The terms shall accordingly be taken to include, but not be limited to, solid-state memories, and optical and magnetic media, including memory internal or external to the processors 1110. Specific examples of machine-storage media, computer-storage media, and/or device-storage media include non-volatile memory including, by way of example, semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1180 may be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1180 or a portion of the network 1180 may include a wireless or cellular network, and the coupling 1182 may be a Code Division Multiple Access (CDMA) connection, a Global System for Mobile communications (GSM) connection, or another type of cellular or wireless coupling. In this example, the coupling 1182 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 1116 may be transmitted or received over the network 1180 using a transmission medium via a network interface device (e.g., a network interface component included in the communication components 1164) and utilizing any one of a number of well-known transfer protocols (e.g., HTTP). Similarly, the instructions 1116 may be transmitted or received using a transmission medium via the coupling 1172 (e.g., a peer-to-peer coupling) to the devices 1170. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1116 for execution by the machine 1100, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method performed by a computer system having a memory and at least one hardware processor, the computer-implemented method comprising:
for each skill in a plurality of skills, computing a skill-to-specialty distribution for a plurality of specialties using a first machine learning model, the skill-to-specialty distribution comprising a skill-to-specialty probability value for each specialty in the plurality of specialties given the skill in the plurality of skills;
for each skill in the plurality of skills, computing a user-to-skill distribution for the plurality of skills based on feature data of a first user of an online service using a second machine learning model, the user-to-skill distribution comprising a user-to-skill probability value for each skill in the plurality of skills given the first user;
computing a user-to-specialty distribution for the plurality of specialties based on the skill-to-specialty distribution and the user-to-skill distribution, the user-to-specialty distribution comprising a user-to-specialty probability value for each specialty in the plurality of specialties given the first user; and
using the user-to-specialty distribution in an application of the online service.

2. The computer-implemented method of claim 1, further comprising:
generating a graph data structure using the user-to-specialty distribution, the generated graph data structure comprising a plurality of entity nodes and a plurality of specialty nodes, each one of the plurality of entity nodes corresponding to a different entity, each one of the plurality of specialty nodes corresponding to a different specialty, each one of the plurality of specialty nodes being connected to each one of the plurality of specialty nodes by an edge that indicates a probability value of the specialty corresponding to the specialty node given the entity corresponding to the entity node,
wherein the using the user-to-specialty distribution in the application of the online service comprises using the graph data structure in the application of the online service.

3. The computer-implemented method of claim 1, wherein the using the user-to-specialty distribution in the application of the online service comprises:
selecting one or more specialties from the plurality of specialties based on the user-to-specialty probability value for each one of the one or more specialties; and
displaying a selectable user interface element for each one of the selected one or more specialties on a computing device of the first user, the selectable user interface element being configured to trigger storing of the specialty as part of a profile of the first user in response to a selection of the selectable user interface element, the profile being stored on the online service.

4. The computer-implemented method of claim 1, wherein the feature data of the first user comprises profile data extracted from a profile of the first user stored on the online service.

5. The computer-implemented method of claim 1, wherein the feature data of the first user comprises interaction data indicating online content with which the first user has interacted with by performing an online action directed towards the online content via the online service.

6. The computer-implemented method of claim 1, further comprising:
for each skill in the plurality of skills, computing an entity-to-skill distribution for the plurality of skills based on feature data of an entity of the online service using a third machine learning model, the entity-to-skill distribution comprising a entity-to-skill probability valueentity-to-skill probability value for each skill in the plurality of skills given the entity; and
computing an entity-to-specialty probability distribution for the plurality of specialties based on the skill-to-specialty distribution and the entity-to-skill distribution, the entity-to-specialty probability distribution comprising a entity-to-specialty probability value for each specialty in the plurality of specialties given the entity,
wherein the using the user-to-specialty distribution in the application of the online service comprises using the user-to-specialty distribution and the entity-to-specialty probability distribution in the application of the online service.

7. The computer-implemented method of claim 6, wherein the entity comprises a second user different from the first user, and using the user-to-specialty distribution and the entity-to-specialty probability distribution in the application of the online service comprises:
based on the user-to-specialty distribution and the entity-to-specialty probability distribution, displaying a selectable user interface element in association with an indication of the second user on a computing device of the first user, the selectable user interface element being configured to trigger, in response to its selection, a transmission of an invitation to connect from the first user to the second user.

8. The computer-implemented method of claim 6, wherein the entity comprises an online job posting, and using the user-to-specialty distribution and the entity-to-specialty probability distribution in the application of the online service comprises:
based on the user-to-specialty distribution and the entity-to-specialty probability distribution, displaying a selectable user interface element in association with an indication of the online job posting on a computing device of the first user, the selectable user interface element being configured to, in response to its selection, trigger a display of the online job posting on the computing device of the first user or initiate an online application process for the online job posting on the computing device of the first user.

9. The computer-implemented method of claim 6, wherein the entity comprises an online course, and using the user-to-specialty distribution and the entity-to-specialty probability distribution in the application of the online service comprises:
based on the user-to-specialty distribution and the entity-to-specialty probability distribution, displaying a selectable user interface element in association with an indication of the online course on a computing device of the first user, the selectable user interface element being configured to, in response to its selection, trigger an online process for playing the online course on the computing device of the first user.

10. The computer-implemented method of claim 1, further comprising training the first machine learning model using a supervised machine learning algorithm.

11. A system comprising:
at least one hardware processor; and
a non-transitory machine-readable medium embodying a set of instructions that, when executed by the at least one hardware processor, cause the at least one hardware processor to perform operations, the operations comprising:
for each skill in a plurality of skills, computing a skill-to-specialty distribution for a plurality of specialties using a first machine learning model, the skill-to-specialty distribution comprising a skill-to-specialty probability value for each specialty in the plurality of specialties given the skill in the plurality of skills;
for each skill in the plurality of skills, computing a user-to-skill distribution for the plurality of skills based on feature data of a first user of an online service using a second machine learning model, the user-to-skill distribution comprising a user-to-skill probability value for each skill in the plurality of skills given the first user;
computing a user-to-specialty distribution for the plurality of specialties based on the skill-to-specialty distribution and the user-to-skill distribution, the user-to-specialty distribution comprising a user-to-specialty probability value for each specialty in the plurality of specialties given the first user; and
using the user-to-specialty distribution in an application of the online service.

12. The system of claim 11, wherein the operations further comprise:
generating a graph data structure using the user-to-specialty distribution, the generated graph data structure comprising a plurality of entity nodes and a plurality of specialty nodes, each one of the plurality of entity nodes corresponding to a different entity, each one of the plurality of specialty nodes corresponding to a different specialty, each one of the plurality of specialty nodes being connected to each one of the plurality of specialty nodes by an edge that indicates a probability value of the specialty corresponding to the specialty node given the entity corresponding to the entity node,
wherein the using the user-to-specialty distribution in the application of the online service comprises using the graph data structure in the application of the online service.

13. The system of claim 11, wherein the using the user-to-specialty distribution in the application of the online service comprises:
selecting one or more specialties from the plurality of specialties based on the user-to-specialty probability value for each one of the one or more specialties; and
displaying a selectable user interface element for each one of the selected one or more specialties on a computing device of the first user, the selectable user interface element being configured to trigger storing of the specialty as part of a profile of the first user in response to a selection of the selectable user interface element, the profile being stored on the online service.

14. The system of claim 11, wherein the feature data of the first user comprises profile data extracted from a profile of the first user stored on the online service.

15. The system of claim 11, wherein the feature data of the first user comprises interaction data indicating online content with which the first user has interacted with by performing an online action directed towards the online content via the online service.

16. The system of claim 11, wherein the operations further comprise:
for each skill in the plurality of skills, computing an entity-to-skill distribution for the plurality of skills based on feature data of an entity of the online service using a third machine learning model, the entity-to-skill distribution comprising a entity-to-skill probability value for each skill in the plurality of skills given the entity; and
computing an entity-to-specialty probability distribution for the plurality of specialties based on the skill-to-specialty distribution and the entity-to-skill distribution, the entity-to-specialty probability distribution comprising a entity-to-specialty probability value for each specialty in the plurality of specialties given the entity,
wherein the using the user-to-specialty distribution in the application of the online service comprises using the user-to-specialty distribution and the entity-to-specialty probability distribution in the application of the online service.

17. The system of claim 16, wherein the entity comprises a second user different from the first user, and using the user-to-specialty distribution and the entity-to-specialty probability distribution in the application of the online service comprises:
based on the user-to-specialty distribution and the entity-to-specialty probability distribution, displaying a selectable user interface element in association with an indication of the second user on a computing device of the first user, the selectable user interface element being configured to trigger, in response to its selection, a transmission of an invitation to connect from the first user to the second user.

18. The system of claim 16, wherein the entity comprises an online job posting, and using the user-to-specialty distribution and the entity-to-specialty probability distribution in the application of the online service comprises:
based on the user-to-specialty distribution and the entity-to-specialty probability distribution, displaying a selectable user interface element in association with an indication of the online job posting on a computing device of the first user, the selectable user interface element being configured to, in response to its selection, trigger a display of the online job posting on the computing device of the first user or initiate an online application process for the online job posting on the computing device of the first user.

19. The system of claim 16, wherein the entity comprises an online course, and using the user-to-specialty distribution and the entity-to-specialty probability distribution in the application of the online service comprises:
based on the user-to-specialty distribution and the entity-to-specialty probability distribution, displaying a selectable user interface element in association with an indication of the online course on a computing device of the first user, the selectable user interface element being configured to, in response to its selection, trigger an online process for playing the online course on the computing device of the first user.

20. A system comprising:
means for, for each skill in a plurality of skills, computing a skill-to-specialty distribution for a plurality of specialties using a first machine learning model, the skill-to-specialty distribution comprising a skill-to-specialty probability value for each specialty in the plurality of specialties given the skill in the plurality of skills;
means for, for each skill in the plurality of skills, computing a user-to-skill distribution for the plurality of skills based on feature data of a first user of an online service using a second machine learning model, the user-to-skill distribution comprising a user-to-skill probability value for each skill in the plurality of skills given the first user;
means for computing a user-to-specialty distribution for the plurality of specialties based on the skill-to-specialty distribution and the user-to-skill distribution, the user-to-specialty distribution comprising a user-to-specialty probability value for each specialty in the plurality of specialties given the first user; and
means for using the user-to-specialty distribution in an application of the online service.
